(19) United States
(12) Patent Application Publication
(10) Pub. No.: US 2008/0247689 A1
(43) Pub. Date: Oct. 9, 2008

(54) Motor

(75) Inventors: Masashi Nomura, Kyoto (JP); Masaaki Mano, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/783,142

(22) Filed: Apr. 6, 2007

(51) Int. Cl. H02K 7/00; H02K 5/16; F16C 17/00

(52) U.S. Cl. 384/129; 310/90; 310/67 R

(57) ABSTRACT

A motor includes a rotor unit, a stator unit, and a bearing mechanism. The bearing mechanism is constituted with a bushing having a hollow substantially cylindrical shape and formed by pressing a metal plate, a first bearing and a second bearing retained radially inside of the bushing, and a spacer arranged axially between the first bearing and the second bearing to determine an axial distance therebetween.

### DESCRIPTION OF THE RELATED ART

1. Field of the Invention

The present invention generally relates to an electrically powered motor and more particularly to the electrically powered motor manufactured in a lower cost.

2. Description of the Related Art

Generally, electric devices such as copying machines, printers, fax machines and the like include brushless motors (hereinafter simply referred to as “motor”). The motor includes a bushing to support a bearing, generally made by die-casting with zinc material or aluminum material. However, adopting the die-casting to a method of manufacturing the bushing will increase a cost of manufacturing the motor. These days, attempts have been made for manufacturing the bushing by press working to lower the manufacturing cost.

The laid open Japanese Patent Publication No. H07-274434 discloses a technique of manufacturing a member to support a ball bearing by a drawing process. The registered Japanese Patent No. 3363095 discloses a technique of manufacturing a member having a cylindrical portion (a center piece), into which a bearing is fitted, by pressing metal plate material.

In the motor adapting the ball bearings, a member supporting the ball bearings needs to be processed with a high dimensional precision. If an appropriate dimensional precision is not maintained, the coaxiallity between the ball bearings and the circularity of portions supporting ball bearings are not adequately maintained and a performance of the motor is degenerated. A motor disclosed in the Japanese Patent Publication No. H07-274434 includes a first ball bearing and a second ball bearing retained at a radially outer surface of a housing. The housing supporting the ball bearings is constituted with two separate members. Since the ball bearings are supported with two members, it is difficult to maintain the adequate coaxiallity between ball bearings. The center piece disclosed in the Japanese Patent No. 3363095 includes a protruding portion, axially inwardly protruding from a body of the center piece and formed by punching a portion of a body thereof, to axially position the ball bearings. In punching the portion of the center piece, the circularity the body supporting the ball bearings may be degenerated. In addition, a radially outer surface of the center piece does not include any portion to axially position an armature, thus, it is difficult to accurately position the armature on the radially outer surface of the center piece.

### SUMMARY OF THE INVENTION

In order to overcome the problems described above, preferred embodiments of the present invention provide a motor having following characteristics.

The motor according to preferred embodiments of the present invention includes a bushing, a first bearing, a second bearing, and a spacer. The bushing is formed by pressing a metal plate and has a bushing cylindrical portion and a bushing flange radially outwardly extending from a lower end of the bushing cylindrical portion. The first and the second bearings are retained at a radially inner surface of the bushing cylindrical portion in an axially separated manner. The spacer is arranged axially between the first and the second bearing to determine an axial distance therebetween. The spacer is press-fitted into the bushing and is retained at the radially inner surface of the bushing cylindrical portion. The spacer includes a spacer cylindrical portion and a spacer flange radially inwardly extending from a lower end of the spacer cylindrical portion. A washer having elasticity in an axial direction is arranged axially between the spacer flange and the first bearing.

A motor according to preferred embodiments of the present invention further includes a shaft retaining inner rings of the first and the second bearings on its radially outer surface, and a first locking mechanism and a second locking mechanism arranged to the shaft and preventing the first and the second bearings from axially moving away from each other. The second locking mechanism is a part of a rotor holder retaining a rotor magnet.

### BRIEF DESCRIPTION OF THE DRAWINGS

FIG. 1 is a vertical sectional view illustrating a configuration of a motor according to a preferred embodiment of the present invention.

FIG. 2 is a magnified vertical sectional view illustrating a bearing mechanism of the motor.

FIG. 3 is a magnified vertical sectional view illustrating another example of a bearing mechanism of the motor.

### DETAILED DESCRIPTION OF THE PREFERRED EMBODIMENTS

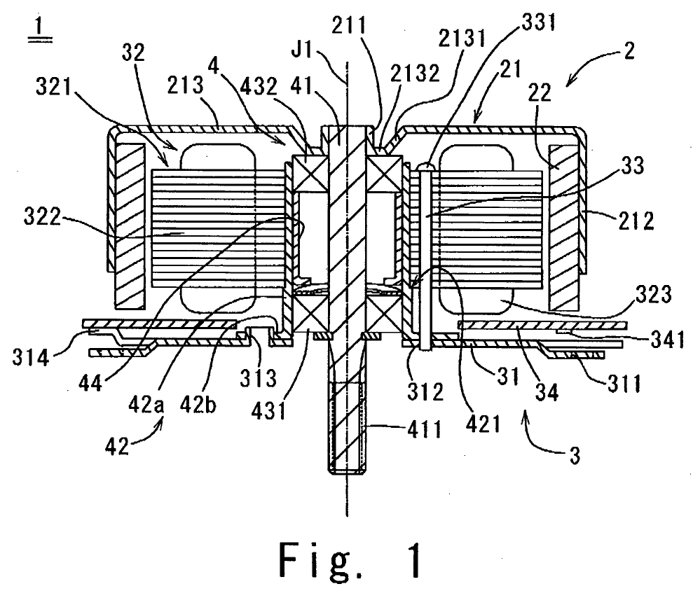

FIG. 1 is a vertical sectional view illustrating a cross section, along a plane including a center axis J1, of an electrically powered motor 1 according to a first preferred embodiment of the present invention. The motor 1 is a brushless type motor, and generally used in a printing machine for feeding paper thereto. As illustrated in FIG. 1, the motor 1 is an outer rotor type motor, and includes a stator unit 3 as a stationary assembly, a rotor unit 3 as a rotatable assembly, and a bearing mechanism 4 supporting the rotor unit 3 in a rotatable manner relative to the stator unit 3. For convenience in the following explanation, a rotor-unit 3 side of the motor 1 will be described as an upper side and a stator unit 3 side as a lower side in an axial direction, but the center axis J1 need not necessarily coincide with the direction of gravity.

The bearing mechanism 4 includes a shaft 41, a bushing 42, a lower bearing 431, an upper bearing 432, and a spacer 44. The bushing 42 includes a cylindrical portion 42a centered on the center axis J1 and a flange 42b radially outwardly extending from a lower end of the cylindrical portion 42a. A shaft 41 is inserted into the bushing 42, the first and the second bearings, and the spacer 44. The lower bearing 431 and the upper bearing 432 are arranged to a radially inner surface of the cylindrical portion 42a of the bushing 42. The spacer 44 has a substantially cylindrical shape and used for axially positioning the lower and upper bearings 431, 432. In the present preferred embodiment of the present invention, the lower and the upper bearings 431 and 432 constituting the bearing mechanism are ball bearings. Hereinafter, the lower bearing 431 is referred to as a first bearing 431, the upper bearing 432 as a second bearing 432, the cylindrical portion 42a as a bushing cylindrical portion 42a, and the flange 42b as a bushing flange 42b.

The rotor unit 3 includes a hollow substantially cylindrical rotor holder 21 supporting the various parts of the rotor unit 3 and a rotor magnet 22 arranged to the rotor holder 21 and encircling the center axis J1.

The rotor holder 21 is made by pressing a metal plate (e.g., galvanized sheet iron). The rotor holder 21 includes a shaft retaining portion 211, a cylindrical portion 212 and a cap 213. The shaft retaining portion 211 has a hollow cylindrical shape into which an upper end of the shaft 41 is inserted and retained. The cylindrical portion 212 has a hollow cylindrical shape with a radially inner surface retaining a radially outer surface of the rotor magnet 22. The cap 213 arranged axially above the bearing mechanism 4 and connects the shaft retaining portion 211 and the cylindrical portion 212. In addition, the cap 213 includes a connecting portion 2131 and a locking portion 2132. At the connecting portion 2131, the cap 211 axially downwardly tilts from a radially outside toward a radially inner direction and connected to the locking portion 2131. The locking portion 2132 radially inwardly extends from a radially inner end of the connecting portion 2131 to the shaft retaining portion 211. A lower surface of the locking portion 2132 abuts against an upper surface of an inner ring 4321 of the second bearing 432, preventing the second bearing 432 from axially upwardly moving.

The stator unit 3 includes a mounting plate 31 and an armature 32. The mounting plate 31 defines a base of the motor 1 and supports various parts of the stator unit 3. In addition, the mounting plate 31 includes a mounting hole 311 used for fixing the motor 1 to the electric device, a screw hole 312 used for fixing the armature 32 to the mounting plate 31 with a screw 33, and a protruding portion 313 used for crimping the busing 42 thereto.

The armature 32 is arranged a radially outside of the bushing cylindrical portion 42a. The armature 32 includes a core 321 which is formed by laminating a plurality of core plates (e.g., silicon steel plates). The core 321 includes a plurality of radially disposed teeth 322 with the center axis J1 as center, and an annular supporting ring which supports the teeth 322 along radially inner sides thereof (i.e., the supporting ring supports the teeth 322 by linking the radially inner ends of the teeth 322). In each of the core plates, portions that correspond respectively to the teeth 322 and to the supporting ring are integrally formed, and thus, the teeth 322 and the supporting ring are magnetically connected. The armature 32 includes a plurality of coils 323 formed by winding wires around the teeth 322 of the core 231 so as to form multilayer of the wires.

The stator unit 3 further includes a circuit board 34 on which a hall element 341 detecting rotation of the rotor unit 3 is arranged. The wires wound around the teeth 322 and defining the coils 323 are connected to the circuit board 34 to supply electricity to the coils 323. By supplying electricity thereto through the circuit board 34, rotational force (torque) centered on the center axis J1 is generated between the armature 32 and the rotor magnet 22, and thus the rotor unit 3 rotates relative to the stator unit 3. A gear 411 (e.g., a helical gear) is arranged to the shaft 41 at a position axially lower from the mounting plate 31. The gear 411 is engaged with other gears to transfer the torque generated by the motor 1 to drive a paper feeding mechanism, for example. The gear 411 may be formed integral with the shaft 41, or may be provided as a separate member attached to the shaft 41.

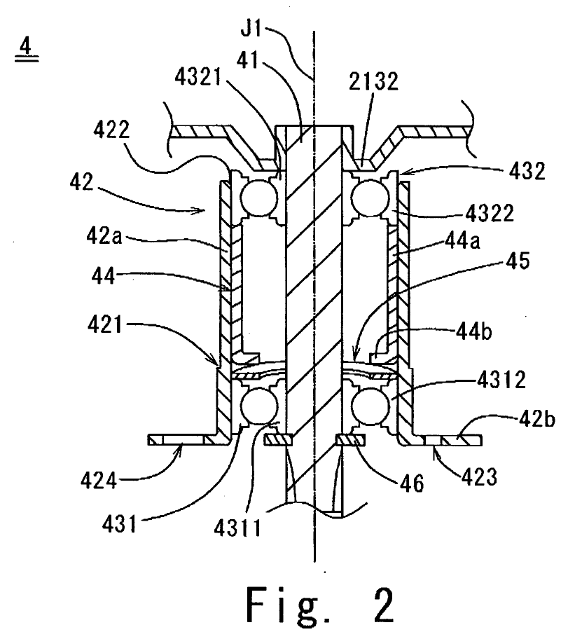

FIG. 2 is a magnified vertical sectional view illustrating the bearing mechanism 4 of the motor 1 in a magnified manner. The bushing 42 is formed by pressing a metal plate (e.g., galvanized sheet iron). In a process of pressing the metal plate, a shoulder 421, at which a radially outer surface is stepped, is formed at the radially outside of the bushing cylindrical portion 42a. When the armature 32 is arranged the radially outside of the bushing cylindrical portion 42a, a lower surface of the supporting ring of the core 321 is abutted against the shoulder 421. Through the configuration, the armature 32 is axially positioned at the radially outside of the bushing cylindrical portion 42a. In the present preferred embodiment of the present invention, the core 321 includes a through hole axially penetrating therethrough. The bushing flange 42b also includes a screw hole 423. The bushing cylindrical portion 42a is loosely fitted into a center opening of the armature 32, and the through hole of the core 321 and the screw hole 423 are aligned with the screw hole 312 of the mounting plate. Then, the armature 32 is secured to the mounting plate 31 with the screw 33. As described above, the core 321 of the armature 32 is axially clamped between a screw head 331 and the shoulder 421 (see FIG. 1). Additionally, the bushing flange 42b includes a through hole 424, into which the protruding portion 313 of the mounting plate 31 is inserted and crimped to fix the bushing to the mounting plate 31.

The mounting plate 31 is formed by pressing a metal plate and includes a plurality of circuit board retaining portions 314 (four of them are provided in the present preferred embodiment of the present invention). The circuit board retaining portions 314 are formed by axially upwardly bending a plurality of portions of the mounting plate 31, and support the circuit board 34 arranged thereon. In other words, a lower surface of the circuit board 34 is abutted against upper surfaces of the circuit board retaining portions 341. The circuit board 34 is secured to the circuit board retaining portions 341 with screws (not shown in Figs.).

The bearing mechanism 4 includes a washer 45 (e.g., a waved washer) abutting and applying load against the first bearing 431 and the spacer 44. The first bearing 431 and the second bearing 432 is fitted into the radially inside of the bushing cylindrical portion 42a. The spacer 44 is arranged axially between the first and the second bearings 431, 432, and the washer 45 is arranged axially between the spacer 44 and the first bearing 431. A guide portion 422 is provided at an upper end of radially inside of the bushing 42. At the guiding portion 422, an inner diameter of the bushing 42 gradually expands toward the axially upper direction. Through the configuration, fitting of the first and the second ball bearings 431, 432 into the bushing 42 is facilitated.

The spacer 44 includes a spacer cylindrical portion 44a and a spacer flange 44b radially inwardly extending from an axially lower end of the spacer cylindrical portion 44a. The spacer 44 is formed by pressing a metal plate (e.g., a galvanized sheet iron), and a curved portion is arranged between the spacer cylindrical portion 44a and the spacer flange 44b. The spacer 44 is fitted into the radially inside of the bushing 42 from an axially upper side thereof, where the guide portion 422 side is arranged, such that the guide portion 422 and the curved portion of the spacer 44 are firstly engaged. Thus, excessive force does not applied to the bushing 42 when the spacer 42 is fitted into the bushing, preventing the radially inner surface of the bushing 42 supporting outer rings of the bearings 431, 432 from being deformed and enabling to fit them smoothly.

As illustrated in FIG. 2, an upper end of the spacer 44 abuts against an outer ring 4322 of the second bearing 432, and a lower end (i.e., the spacer flange 44b) abuts against the washer 45. Through the configuration, an axial distance between the first bearing 431 and the second bearing 432 is determined. The washer 45 is an annular elastic member having radially inner and outer ends and wavy axial surfaces. The washer 45 also abuts against an outer ring 4312 of the first bearing 431.

The spacer flange 44b of the spacer 44 has an inner diameter which is substantially the same or smaller than that of the radially inner end of the washer 45. Through the configuration described above, the washer 45 is stably arranged between the first bearing 431 and the spacer flange 44b of the spacer 44.

The bearing mechanism 4 includes locking mechanisms preventing the first and the second bearings 431, 432 from axially separating each other. Particularly, a locking member 46 is attached a lower side of the shaft 41 and abutted against an inner ring 4311 of the first bearing 431 so as to prevent the first bearing 431 from axially downwardly moving, and the rotor holder 21 is attached to the upper end of the shaft 311 and abutted against the inner ring 4321 of the second bearing 432 so as to prevent the second bearing 432 from axially upwardly moving. The rotor holder 21 is configured that the locking portion 2132 is abutted against the inner ring 4321 of the second bearing 432 when the rotor holder 21 is attached to the shaft 311. Through the configuration described above, the first and the second bearings 431, 432 are prevented from axially separating each other.

The washer 45 has elasticity, and generates load in the axial direction separating the first bearing 431 from the spacer 44. The inner ring 4311 of the first bearing 431 abuts against the locking member 46 attached to the shaft 311, and the outer ring 4312 of the first bearing 431 abuts against the washer 45, thus the washer 45 applies predetermined axial load to the first bearing 431 and the spacer 44. In addition, the upper end of the spacer 44 abuts against the outer ring 4322 of the second bearing 432, and the inner ring 4321 of the second bearing 432 abuts against the locking portion 2132 of the rotor holder 21. With the configuration described above, the first and the second bearings 431, 432 are axially positioned while the predetermined load generated by the washer 45 is applied thereto, thus the first and the second bearings 431, 432 are axially positioned in predetermined positions.

As described above, in the bearing mechanism 4 of the motor 1 according to the present preferred embodiment of the present invention, the first and the second bearings 431,432 are supported on the radially inner surface of the bushing 42 which is a single member, improving the coaxiallity between the first and the second bearings 431, 432. In addition, additional processes for providing shoulders and/or notches to the radially inner surface of the bushing 42 for axially positioning the first and the second bearings 431, 432, preventing the radially inner surface of the bushing 42 supporting outer rings 4322 and 4312 of the first and the second bearings 431, 432 from being deformed. As a result, manufacturing of the bushing 42 is simplified and the cost of manufacturing the motor 1 is reduced. In addition, the shoulder 421 for axially positioning the armature 32 may be easily formed on the radially outer surface of the bushing cylindrical portion 42a by press working. Thus, without any special tools, the armature 32 is axially positioned the radially outside of bushing. As a result, the cost of manufacturing the motor 1 is further reduced. In the present preferred embodiment of the present invention, the same kind of bearings having substantially the same diameter are used as the first bearing 431 and the second bearing 432, simplifying the shape of the bushing cylindrical portion 42a, and further reducing the cost of manufacturing the motor 1.

In the present preferred embodiment of the present invention, the spacer 44 is formed by press working, facilitating manufacturing of the motor 1 and lowering the cost of manufacturing the motor 1.

The washer 45, applying load in the axial direction to the first bearing 431 and the spacer 44, is provided to the bearing mechanism 4, preventing run-out of the shaft 41 during rotation of the motor 1. In the present preferred embodiment of the present invention, the spacer 44 is fixed to the radially inner surface of the bushing 42 by press fitting, thus an adhesive may not be used for fixing the spacer 44, preventing the coaxiallity of the first and the second bearings 431, 432 from being influenced by thermal expansion of the adhesive.

While embodiments of the present invention have been described in the foregoing, the present invention is not limited to the embodiments detailed above, in that various modifications are possible.

In the above description, the spacer 44 is formed by press working. However, the spacer 44 may be formed by cutting annular material.

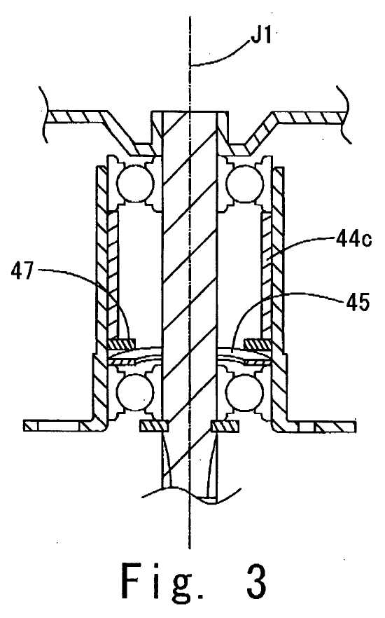

In the above description, the spacer 44 includes the spacer flange 44b extending the lower end of the spacer cylindrical portion 44a. However, the spacer 44 may be a cylindrical shape member without the spacer flange 44b. For example, as illustrated in FIG. 3, an annular member 47 may be arranged between the washer 45 and a spacer 44c. It is preferable to provide the washer 45 applying load to the spacer 44c and the first bearing 431. However, it is not necessary to provide the washer 45 in case that the first and the second bearing 431, 432 are arranged precisely with a predetermined axial distance defined therebetween.

In the preferred embodiments of the present invention, the shape of the spacer cylindrical portion 44a of the spacer 44 is not limited to the hollow substantially cylindrical shape. The shape thereof may any shapes as long as it can support the outer ring 4322 of the second bearing 432, such as a substantially polygonal pole shape and the like. The outer ring 4322 of the second bearing 432 may be abutted against the spacer 44 at circumferentially spaced positions.

In the above description, the washer 45 is the waved washer. However, the washer 45 may be any members which applies appropriate axial load to the spacer 44 and the first bearing 431. For example, the washer 45 may be a coil spring, a disk spring, or the like. Other types of bearings such as sliding bearings made of sintered material may be used as the first and the second bearings 431,432 of the bearing mechanism 4, in stead of the ball bearings. However, the preferred embodiment of the present invention is preferably applied to the bearing mechanism 4 adopting the ball bearings requiring a high circularity, the dimensional precision, and the coaxiallity therebetween.

A plurality of shoulders 421 may be arranged at the radially outside of the bushing cylindrical portion 42a in a circumferentially spaced manner. The locking portion 2132 may not be a part of the rotor holder 21. For example, another member abutting against the inner ring 4321 of the second bearing 432 may be provided to the shaft 41. The shaft 41 may include a convex portion abutting against the inner ring 4321 of the second bearing 432. The locking member 46 may be in any other forms as long as it prevents the first bearing 431 from axially moving. For example, the locking member 46 may be integrally formed with the shaft 41.

The motor 1 according to the preferred embodiments of the present invention does not necessarily have to be the outer-rotor type, but may an inner-rotor type, in which the rotor magnet 32 is arranged radially inside of the armature 32. The motor 1 according to the preferred embodiments of the present invention may be used for other than the driving sources of the printer. It may be used for a copying machine, a facsimile machine, and other industrial purposes, for example.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a shaft coaxial with a rotational axis of the motor;
a bushing including a bushing cylindrical portion having a hollow substantially, cylindrical shape centered on the rotational axis, and a bushing flange extending radially outwardly from an axially lower end of the bushing cylindrical portion;
a first bearing and a second bearing arranged in an axially separated manner and retained at a radially inner surface of the bushing cylindrical portion of the bushing, the second bearing being arranged at a position axially upside of the first bearing; and
a spacer arranged axially between the first bearing and the second bearing at the radially inner surface of the bushing cylindrical portion and determining an axial distance therebetween, wherein the bushing is a pressed metal plate.

2. The motor as set forth in claim 1, wherein the spacer includes a spacer cylindrical portion and a spacer flange extending radially inwardly from an axially lower end of the spacer cylindrical portion.

3. The motor as set forth in claim 2, wherein an axially elastic washer is arranged axially between the spacer flange and the first bearing.

4. The motor as set forth in claim 3, wherein the axially elastic washer is a waved washer having a substantially annular shape with a center hole, and a inner diameter the spacer flange is substantially the same or smaller than a diameter of the center hole of the wave washer.

5. The motor as set forth in claim 2, wherein the spacer cylindrical portion has a hollow substantially, cylindrical shape.

6. The motor as set forth in claim 2, wherein the spacer cylindrical portion is a pressed metal plate.

7. The motor as set forth in claim 2, wherein the first bearing and the second bearing are ball bearings.

8. The motor as set forth in claim 7, further includes:
a first locking mechanism and a second locking mechanism arranged at portions of the shaft axially outside of the first bearing and the second bearing respectively, and preventing the first bearing and second bearing from being axially apart from each other; and
an axially elastic washer arranged axially between the spacer flange and the first bearing, and applying load in an axially outward direction to the first bearing and the spacer,
wherein a first outer ring of the first bearing abuts against the axially elastic washer and a first inner ring of the first bearing abuts against the first locking mechanism, and a second outer ring of the second bearing abuts against the spacer and a second inner ring of the second bearing abuts against the second locking mechanism.

9. The motor as set forth in claim 8, further comprising:
a rotor magnet rotatable with the shaft; and
a rotor holder having a hollow cylindrical portion retaining the rotor magnet and a cap covering axially upward of the bushing and radially inwardly extending from an axially upper end of the hollow cylindrical portion,
wherein the second locking mechanism is a part of the rotor holder.

10. The motor as set forth in claim 9,
wherein the second locking mechanism is a part of the cap,
the cap includes a connecting portion at which a part of the cap is axially downwardly tilted toward the second bearing and is connected to the second locking mechanism, and
a shaft retaining portion having a hollow substantially, cylindrical shape into which the shaft is inserted and axially extending from the second locking mechanism.

11. The motor as set forth in claim 10, wherein the rotor holder is formed by pressing a metal plate.

12. The motor as set forth in claim 2, wherein the spacer cylindrical portion and the spacer flange are connected by a curved portion, and an axially upper end of a radially inside of the bushing cylindrical portion includes a guide portion, at which an inner diameter of the bushing gradually increases toward an axially upper direction.

13. The motor as set forth in claim 1, wherein an outer diameter of the first bearing and the second bearing is substantially the same each other.

14. The motor as set forth in claim 1, further comprising an armature arranged at a radially outside of the bushing, wherein the bushing includes a shoulder to which the armature abuts for axially positioning the armature.

15. The motor as set forth in claim 14, wherein an outer diameter of the first bearing and the second bearing is substantially the same each other.

16. The motor as set forth in claim 1, further comprising:
a mounting plate attached to a lower surface of the bushing flange and having a circuit board retaining portion at which the mounting plate is axially upwardly raised; and
a circuit board surrounding the bushing and retained on the circuit board retaining portion,
wherein the mounting plate is a pressed metal plate, and the mounting plate and the circuit board are arranged at axially below the armature.

17. The motor as set forth in claim 1, wherein the spacer is press-fitted into the bushing cylindrical portion of the bushing.

18. The motor as set forth in claim 1, wherein the shaft axially extends below from an axially lower end of the bushing, and an axially lower end of the shaft includes a geared portion.
